(19) United States
(12) Patent Application Publication
(10) Pub. No.: US 2018/0139195 A1
(43) Pub. Date: May 17, 2018

(54) SYSTEM AND METHOD FOR PAIRING USERS WITH SERVICE PROVIDERS

(71) Applicants: David Isaacson, Philadelphia, PA (US); Tory Wergelis-Isaacson, Philadelphia, PA (US); Ethan Wergelis-Isaacson, Philadelphia, PA (US); Dylan Wergelis-Isaacson, Philadelphia, PA (US)

(72) Inventors: David Isaacson, Philadelphia, PA (US); Tory Wergelis-Isaacson, Philadelphia, PA (US); Ethan Wergelis-Isaacson, Philadelphia, PA (US); Dylan Wergelis-Isaacson, Philadelphia, PA (US)

(21) Appl. No.: 15/352,526

(22) Filed: Nov. 15, 2016

(51) Int. Cl. H04L 29/06; H04L 29/08; G06Q 30/00

(52) U.S. Cl. CPC H04L 63/08; H04L 63/0428; G06Q 30/01; H04L 67/18

(57) ABSTRACT

A system and computer implemented method for pairing an service provider with a user comprises a memory unit to store a database comprising one or more records associated with at least one service provider, and a set of program modules. The system further comprises a processor to execute the set of program modules. The set of program modules comprises a location detection module, a service provider availability module, a service provider selection module, and a communication module. The service provider availability module is configured to determine availability of the service provider in a vicinity of a location of the user. The service provider selection module is configured to assign the service provider to the user. The communication module is configured to request the service provider to provide a service to the user, thereby pairing at least one service provider with the user.

### BACKGROUND OF THE INVENTION

### A. Technical Field

The present invention generally relates to the technical field of social media, and more specifically relates to a system and method for pairing users with service providers.

### B. Description of Related Art

On-demand mobile applications have pervaded every aspect of life in the twenty first century. Examples of the on-demand mobile applications include but are not limited to Repair Pal, Uber, and Showaround. Today, users access the on-demand mobile applications for multiple purposes. As often is the case, users access the on-demand mobile applications to acquire information about nearby restaurants, lodges, electronics showrooms, and car repair centers. Further, the users access the on-demand mobile applications to connect with service providers having expertise in a plurality of fields.

In an existing system, an on-demand mobile application directs a user to a service provider in the vicinity of the user by transmitting to the user, a location of the service provider. The user is thereby enabled to request and purchase one or more services from the service provider in an on-demand mobile application. However, the on-demand mobile application as described in the example has a serious drawback. The on-demand mobile application lacks a feature for enabling any person to become a service provider offering a plurality of services based on any knowledge category, thus restricting the user to only be enabled to obtain services within a specified service category. Further the on-demand mobile application lacks the feature of matching the user with the service provider based on a plurality of profile characteristics including the age of the user and the service provider, languages spoken by the user and the service provider, and personal preferences of the user and the service provider. Furthermore, the on-demand mobile application lacks security features to ensure that the service provider and the user are definitively identified to each other prior to commencement of the service. Furthermore the on-demand applications lacks a feature to track the amount of time that the service provider is engaged in the activity of providing the service and extending the service if agreed to by the service provider and the user.

Therefore, there is a need in the art for a secure on-demand mobile application and management platform having a feature of enabling any person with any knowledge area or expertise to offer their services as service provider in an on-demand fashion. Further there is a need in the art for a secure on-demand mobile application and management platform that enables searching for and pairing users with service providers based on a plurality of conditions including service requested, location and profile characteristics.

### SUMMARY OF THE INVENTION

The present invention relates to a system and method for pairing a user with service providers.

In one embodiment of the present invention, a system for pairing a service provider with the user comprises a memory unit to store one or more records associated with at least one service provider in a computer system. The one or more records comprise information regarding location of at least one service provider and personal details of the at least one service provider. The personal details comprise a list of services offered by the service provider, age of the service provider, sex of the service provider, and languages known to the service provider. Further, the system comprises an input module, executed by the processor to receive information about the user. Information about the user comprises name and user preferences of the user, the user preferences comprising age of the service provider as preferred by the user, location of the service provider as preferred by the user, sex of the service provider as requested by the user, a list of services required by the user, and languages spoken by the service provider as preferred by the user. Furthermore, the system comprises a location detection module, executed by the processor to determine a location of the user, with a location detector module. Moreover, the system comprises a service provider availability module, to determine availability of the at least one service provider in a vicinity of the location of the user. Furthermore, the system comprises a compatibility module, to calculate compatibility of the list of services required by the user with the list of services offered by the at least one service provider. Further, the system comprises a service provider selection module to assign at least one service provider to the user, based upon the list of services required by the user being compatible with the list of services offered by the at least one service provider. Furthermore, the system comprises a security key generator module to generate a security key. Furthermore, the system comprises a communication module to transmit the location of the user to at least one service provider. Further, the communication module transmits the security key to the user. The communication module transmits the security key to the service provider. The communication module requests, at least one service provider to provide the list of services offered by at least one service provider, to the user, thereby pairing at least one service provider with the user.

In one embodiment of the present invention, the list of services offered by the at least one service provider comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. In yet another embodiment, the list of services required by the user comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. In yet another embodiment, the location detection module determines the location of the user with a Global Positioning System (GPS). In yet another embodiment, the security key enables the user to authenticate the at least one service provider. In yet another embodiment, the service provider is at least one of a professional service provider and an amateur service provider. In yet another embodiment, the service provider is registered with the database.

In one embodiment of the present invention, a computer-implemented method of pairing a service provider with a user comprises storing one or more records associated with at least one service provider in a computer system. The one or more records comprise information regarding location of at least one service provider and personal details of the at least one service provider. The personal details comprise a list of services offered by the service provider, age of the service provider, sex of the service provider, images of the service provider, date of birth of the service provider, fees charged by the service provider, and languages known to the service provider. Further, the method comprises receiving, at a processor, via an input module, information about the user. Information about the user comprises name and user preferences of the user, the user preferences comprising age of the service provider as preferred by the user, location of the service provider as preferred by the user, a list of services required by the user, sex of the service provider as required by the user, and languages spoken by the service provider as preferred by the user. Furthermore, the method comprises determining, at the processor, via a location detection module, a location of the user, with a location detector module. Moreover, the method comprises determining at the processor via a service provider availability module, availability of the at least one service provider in a vicinity of the location of the user. In one embodiment, the method comprises determining availability of the service provider within a specified vicinity. Furthermore, the method comprises calculating, at the processor, via a compatibility module, compatibility of the list of services required by the user with the list of services offered by the at least one service provider. Further, the method comprises assigning, at the processor, via a service provider selection module the at least service provider to the user, based upon the list of services required by the user being compatible with the list of services offered by the at least one service provider. Further, the method comprises transmitting assignments are to the user mobile device via the communication module and enabling the user to select the service provider based on at least one service provider being compatible with the list of service requested by the user. Furthermore, the method comprises generating, at the processor, via a security key generator module, a security key. Furthermore, the method comprises transmitting, at the processor, via the communication module, the location of the user to at least one service provider. Moreover, the method comprises transmitting, at the processor, via the communication module, the security key to the user. Further, the method comprises requesting, at the processor, via the communication module, the at least one service provider to provide the list of services offered by the at least one service provider, to the user, thereby pairing the at least one service provider with the user.

In one embodiment, an administrative unit transmits the security key to the user. The service provider arrives at the location of the user and the user relays the security key verbally to the service provider. The service provider enters the security key into a security module. The security key is transmitted to the administrative unit and a check is done to confirm a match. For checking, the service provider enters the security key into a service provider device. If there is a match, the service provider provides a service to the user. The administrative unit initiates a clock countdown based on a designated activity time segment. The administrative unit counts down until 10 minutes before end of designated activity in the service providers profile and a message is sent to user to ask if the user agrees to extend the service. If the user agrees, a new designated extension time is assigned. The administrative unit stores service provider profile information that has been previously entered into the administration unit by the service provider via at least one of a web page and an application window. Profile information includes but is not limited to name, address, phone number and profile characteristics comprising age, sex, services provided. This service provider database is queried by the user app requests.

### BRIEF DESCRIPTION OF DRAWINGS

FIG. 1 is a block diagram of an environment implemented in accordance with various embodiments of the invention.

FIG. 2 is a block diagram of user mobile application unit in accordance with various embodiments of the invention.

FIG. 3 is a block diagram of a service provider mobile application in accordance with various embodiments of the invention.

FIG. 4 is a block diagram of an administrative unit, according to another embodiment of the present invention.

FIG. 5 is flow chart of a computer-implemented method of directing a service provider to a user, according to yet another embodiment of the present invention.

FIG. 6 is a screenshot view of a service request screen according to yet another embodiment of the present invention.

FIG. 7 is a screenshot view of a user screen according to yet another embodiment of the present invention.

FIG. 8 is flow chart of a computer-implemented method of registering a service provider in a system, according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

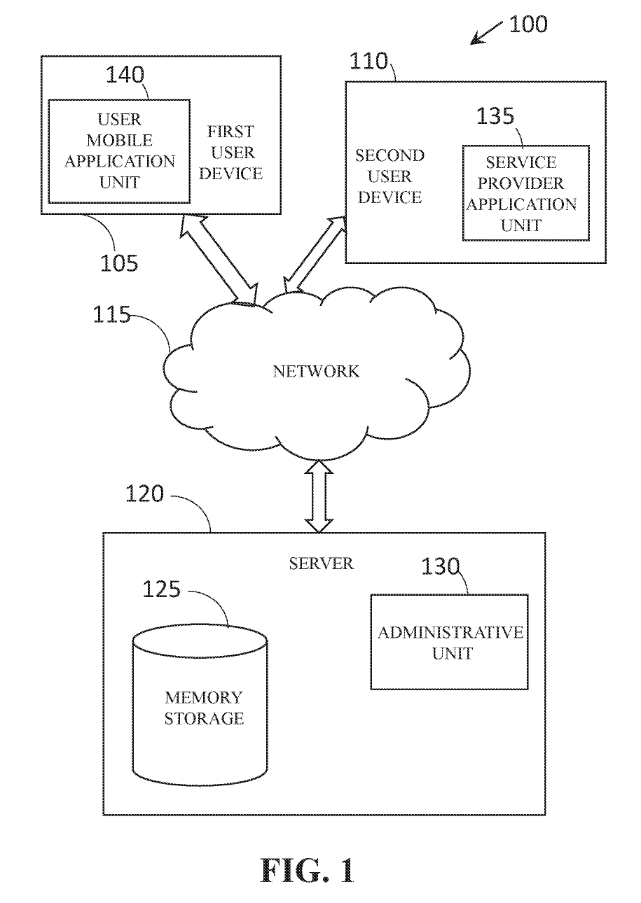

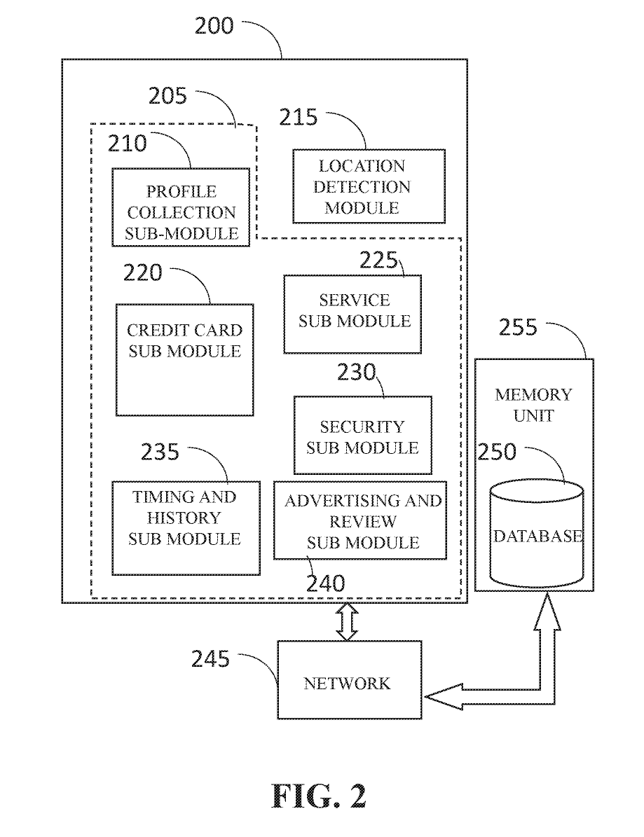

FIG. 1 is a block diagram of an environment 100 in accordance with which various embodiments of the present invention are implemented. The environment 100 comprises a first user device 105, a second user device 110, a network 115, and a server 120. The first user device 105 and the second user device 110 are at least one of tablet computers, personal computers, smart phones, smart televisions and laptops. In one embodiment of the present invention, the first user device 105 and the second user device 110 comprises a Global Positioning System (not shown here). In one example, the first user device 105 enables a user to communicate with the server 120 via the network 115. The first user device 105 is at least one of laptops, personal computers, smart phones, smart televisions, and tablet computers. The first user device 105 comprises a user mobile application unit 140. A block diagram of an exemplary implementation of the user mobile application unit 140 is illustrated in FIG. 2.

Referring to FIG. 2, a user mobile application unit 200 comprises an input module 205 and a location detection module 215. The user mobile application unit 200 communicates with a memory unit 255 in a server (not shown) via a network 245. The network 245 is at least one of a mobile network, a wide area network and a wireless radio network. The memory unit 255 comprises a database 250 comprising one or more records. The records comprise a first list of services offered by at least one service provider, age of the service provider, and a list of languages spoken by the service provider. The first list of services includes, but is not limited to a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. The memory unit 255 transmits the records to the user mobile application unit 200. As mentioned earlier, the user mobile application unit 200 comprises the input module 205 and the location detection module 215. The location detection module 215 is implemented in an Application Specific Integrated Circuit Chip. The location detection module 215 comprises a Global Positioning System (GPS) device. The location detection module 215 receives information regarding location of the user mobile application unit 200 from the GPS device. Further, the location detection module 215 communicates with the GPS device (not shown). Further, the location detection module 215 receives one or more data items from the GPS module and determines a location of the user based upon the one or more data items. The one or more data items comprise information regarding coordinates of the user in accordance with one of a radial, linear and cartographical system. The location detection module 215 transmits information regarding location of the user mobile application unit 200 into the input module 205.

The input module 205 receives information about the user. Information about the user comprises name and user preferences of the user. The user preferences of the user is at least one of an age of the service provider as preferred by the user, a location of the service provider as preferred by the user, a list of services required by the user, and languages spoken by the service provider, as preferred by the user. The input module 205 comprises a profile collection sub-module 210, a credit card collection sub-module 220, a service sub-module 225, and a security sub module 230, a timing and history sub-module 235, an advertising and review sub-module 240. The profile collection sub-module 210 receives profile information of the user. The profile information 230 comprises name of the user, age of the user, hobbies of the user, address of the user and the contact details of the user. The credit card collection sub-module 220 receives payment information and credit card details from the user. The service sub module 225 receives a second list of services from the user. The second list of services are services required by the user.

The second list of services includes, but is not limited to a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. Further, the service sub-module 225 retrieves the records of the service provider from the memory unit 255 and displays the records to the user via a display device (not shown). Furthermore, the service sub-module 225 enables the user to select the service provider. Furthermore, the service sub-module 225 estimates expenses for the service provider to perform at least one service among the first list of services. The service sub module 225 receives one of a confirmation and a rejection from the service provider to deliver the first list of services. Furthermore, the service sub-module 225 displays the confirmation received from the service provider. The security sub-module 230 generates a security key. The timing and history sub-module 235 calculates time taken by the service provider to deliver at least one service. Further, the timing and history sub-module 235 records information about at least one of service requests, confirmations, rejections, and time taken by the service providers. The advertising and review sub-module 240 receives and tracks information regarding location of user mobile application unit 200 from the GPS device. Further, the advertising and review sub-module 240 enables the user to rate the service provider by providing at least one of a star rating and a vote based rating.

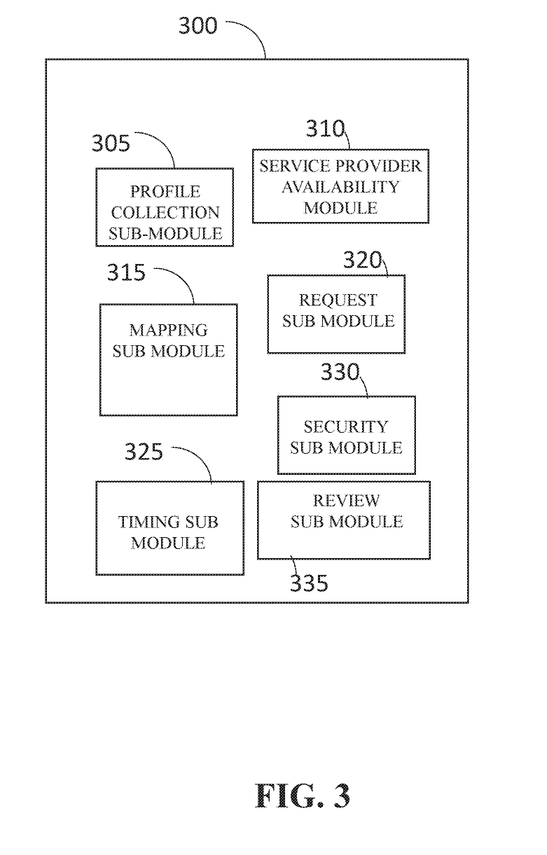

Referring back to FIG. 1, the environment 100 further comprises the second user device 110. The second user device 110 is at least one of laptops, personal computers, smart phones, smart televisions, and tablet computers. The second user device 110 comprises a service provider application unit 135. A block diagram of an exemplary implementation of the service provider application unit 135 is illustrated in FIG. 3.

Referring to FIG. 3, a service provider application unit 300 comprises a profile collection sub-module 305, a service provider availability sub-module 310, mapping sub-module 315, a request sub-module 320, a timing sub-module 325, a security sub-module 330, and a review sub-module 335. The profile collection sub-module 305 maintains profile database and descriptions of at least one service provider. The service provider availability sub-module 310 enables at least one service provider to notify at least one user of availability of the at least one service provider. The mapping sub-module 315 create a map display indicating location of the at least one service provider and at least one user. The request sub-module 320 enables at least one service provider to one of accept and reject a service request. The security sub-module 330 accepts a security key to confirm identity of the user and the at least one service provider. The timing sub-module 325 displays time taken by at least one service provider to deliver a service. The review module 335 enables the service provider to rate the user. The service provider application unit 300 enables the at least one service provider to communicate with a server (not shown). A block diagram of the server is illustrated in FIG. 1.

Referring back to FIG. 1, the server 120 is at least one of a file server, a database server, a communications server, an applications server, a cloud server, and a domain server. The server 120 comprises an administrative unit 130 and a memory unit 125. The memory unit 125 is at least one of a flash memory, magnetic tapes, optical discs, and floppy discs. The memory unit 125 comprises a database of one or more records. The records comprise at least one of names, and lists of services offered by a plurality of service providers registered with the server 120. As mentioned earlier, the server 120 comprises the administrative unit 130.

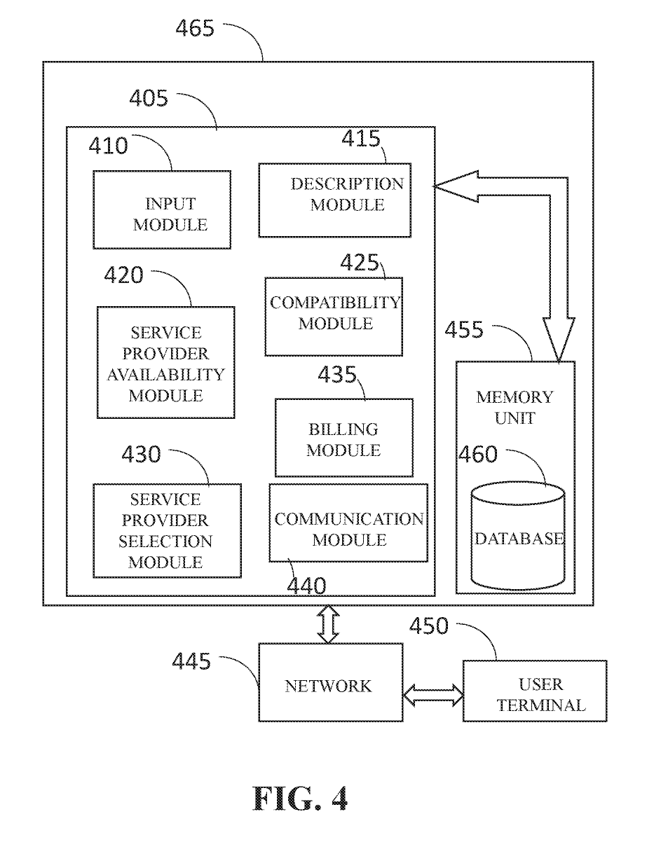

The administrative unit 130 is at least one of a Field Programmable Gate Array, a microprocessor, an Application Specific Integrated Circuit, a virtual machine, an interconnection of digital logic gates, a microcontroller, a microprocessor, a mainframe data processor, and a multicore processor. The administrative unit 130 is configured to execute program modules stored in the memory unit 125. In one exemplary illustration of functioning of the present invention, the administrative unit 130 directs at least one service provider to the user by executing the set of program modules stored in the memory unit 125. In one embodiment, the present invention is implemented as a website. In another embodiment, the present invention is implemented as a mobile application. A block diagram of an exemplary illustration of the administrative unit 130 is illustrated in FIG. 4.

Referring to FIG. 4, an administrative unit 405 is implemented inside a device 465 connected to a network 445. In one embodiment of the present invention, the device 465 is a server. In another embodiment of the present invention, the device 465 is at least one of a laptop, a personal computer, a smart phone, a smart television, and a tablet computer. The network 445 is at least one of a Local Area Network, a Wide Area Network, a Wireless Network, a telecommunication network, a mobile network, and Internet. The network 445 enables the user to communicate with the device 465. The user is connected to the network 445 via a user terminal 450. The user terminal 450 is at least one of a laptop, a personal computer, a smart phone, a smart television, and a tablet computer. The user terminal 450 comprises a global positioning system (not shown).

Further, the device 465 comprises a memory unit 455 and the administrative unit 405. The memory unit 455 is at least one of a volatile memory, non-volatile memory, Read Only memory (ROM), Random Access Memory (RAM), and a flash memory. The memory unit 455 comprises a database 460 of one or more records. The records comprise at least one of names, locations of a plurality of service providers registered with the administrative unit 405. In one embodiment, the plurality of the service providers are vetted by the administrative unit 405 prior to registration. The memory unit 455 further comprises a first list of services offered by the plurality of service providers, age of the plurality of service providers, sex of the service provider, and a list of languages spoken by at least one service provider. The first list of services comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. The plurality of service providers are connected to the administrative unit 405 via a plurality of electronic devices. The plurality of electronic devices comprise laptops, personal computers, smart phones, smart televisions, and tablet computers. The memory unit 455 transmits the records to the administrative unit 405.

The administrative unit 405 is at least one of a processor, a Field Programmable Gate Array, a microprocessor, an Application Specific Integrated Circuit, a virtual machine, and an interconnection of digital logic gates. The administrative unit 405 executes a set of program modules. The set of program modules comprises an input module 410, a description module 415, a service provider availability module 420, a compatibility module 425, a service provider selection module 430, a billing module 435, and a communication module 440. In one embodiment of the present invention, source code for the set of program modules is stored in the memory unit 455. In another embodiment of the present invention, functionality of the set of program modules is implemented in a network of corresponding Application Specific Integrated Circuit (ASIC) Chipsets configured inside the administrative unit 405.

The administrative unit 405 receives information about the user via an input module 410. The input module 410 is configured to receive information about the user. In one embodiment of the present invention, information about the user pertains to at least one of name of the user, user preferences of the user, personal details of the user, and a second list of services required by the user. The second list of services comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service. The user preferences of the user comprise age of the service provider as preferred by the user, location of the service provider as preferred by the user. In one embodiment of the present invention, the input module 410 receives information about the user via an input component of the device 465. In one embodiment of the present invention, the input module 410 is configured to receive information regarding user preferences. The user preferences comprise preference for at least one service provider to be at a user-specified age and preference for at least one service provider to speak a user-specified language. An example of the input component includes but is not limited to a microphone, a keyboard, a mouse pointer, and a video camera. The input module 410 receives information about the user in the form of at least one of a voice command, text command, a gesture based command and a mouse-click. The input module 410 is configured to receive information about the user. The information about the user comprises name and user preferences of the user. The user preferences comprises age of the service provider as preferred by the user, location of the service provider as preferred by the user, a second list of services required by the user, and languages spoken by the service provider as preferred by the user. Further, the input module 410 communicates with a GPS device (not shown) of the user terminal 450. Further, the input module 410 receives one or more data items from the GPS module and determines a location of the user based upon the one or more data items. The one or more data items comprise information regarding coordinates of the user in accordance with one of a radial, linear and cartographical system. The input module 410 transmits the information to the description module 415. The description module 415 maintains database of the users and the information about the user. Further, description module 415 maintains database of the service providers, the records about the service providers and availability of the service providers. The input module 410 transmits information regarding the location of the user and information about the user from the description module 415, to the service provider availability module 420.

In one embodiment of the present invention, the service provider availability module 420 is implemented in Application Specific Integrated Circuit Chip. The service provider availability module 420 analyses the records associated with the plurality of service providers. It is noted that the records comprises locations of the plurality of service providers. Further, the service provider availability module 420 selects at least one service provider from the plurality of service providers based upon the service provider being in vicinity of the location of the user. Further, the service provider availability module 420 analyses one or more records associated with the service provider. If the service needed by the user is among the list of services offered by the service provider, then the service provider availability module 420 transmits the records associated with the service provider to the service provider selection module 420. In one embodiment, if the age of at least one service provider is same as the user specified age of the service provider, then the service provider availability module 420 transmits the records associated with the service provider to the compatibility module 425. The compatibility module 425 is configured to calculate compatibility of the first list of services with the second list of services. The compatibility module 425 is configured to calculate compatibility of the personal details of the service provider with the user preferences. The compatibility module 425 transmits information pertaining to compatibility to the service provider selection module 430.

The service provider selection module 430 assigns the service provider to the user. The service provider selection module 430, is configured to assign at least one service provider to the user, based upon the first list of services being compatible with the second list of services and the personal details of the service provider being compatible with the user preferences. Further, the service provider selection module 430 transmits the records associated with the service provider to the billing module 435 and the communication module 440. The billing module 435 tracks monetary charges by the service provider to the user. In one example, the service provider selection module 230 requests a confirmation message from the user prior to assigning the service provider to the user. The user is enabled to provide the confirmation message as one of a text message, email, and a voice command.

The communication module 440 transmits the location of the user to at least one electronic device among the plurality of electronic devices associated with the service provider. In one example, the communication module 440 further transmits a notification regarding the confirmation from the user. In another example, the communication module 440 requests a confirmation message from the service provider prior to assigning the service provider to the user. The service provider is enabled to provide the confirmation message as one of a text message, email, and a voice command. In yet another example, the communication module 440 authenticates the user and the service providers by sending and receiving a security key between the user and the service providers.

Moreover, the communication module 440 requests the user to make a payment for the service described in at least one service request. The payment comprises expenses for performing the service. Examples of the expenses include service charge, tip, and transport expenses. The communication module 440 transmits the notifications and requests as at least one of a text message, a voice message and an electronic mail. Further, the communication module 430 transmits an invoice to the user and the service provider.

The communication module 440 transmits at least one service request to the electronic device. Further, communication module 440 requests the service provider to deliver the first list of services to the user, thereby pairing the service provider to the user.

In one embodiment of the present invention, the administrative unit 405 enables the user to evaluate and rate the service provider based on the service done by the service provider. The user rates the service provider by providing at least one of a star rating, a badge, an award and a written testimony. Further, the administrative unit 405 enables the service provider to evaluate and rate the user. The service provider rates the user by providing at least one of a star rating, a badge, an award and a written testimony. Further, the administrative unit 405 enables the user and the plurality of service provider to form business groups. The administrative unit 405 enables the user to add and remove at least one service provider from the social group. In another embodiment, the administrative unit 405 displays relative positions of the user and the service provider on a map and informs the user of an estimated time of arrival of the service provider.

In another embodiment of the present invention, the electronic device of the service provider comprises a service provider mobile application. The service provider mobile application enables the service provider to register, and sign in to the administrative unit 405. Furthermore, the service provider mobile application sends a message to the administrative unit which then transmits a message to the user informing the user of availability of the service provider in proximity of the user. Furthermore, the service provider mobile application enables the service provider to block the user from contacting the service provider.

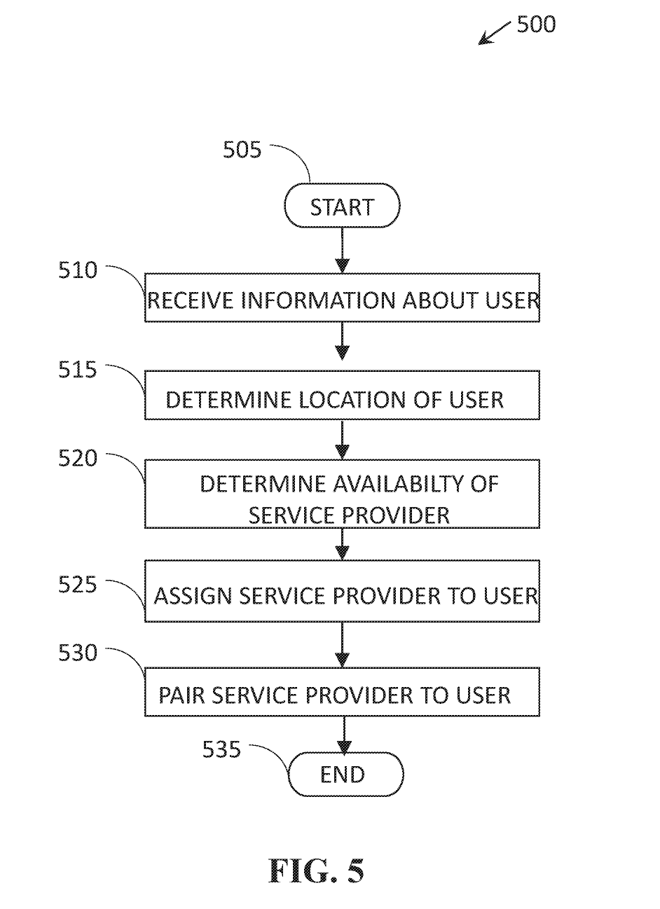

FIG. 5 is flow chart illustrating a computer-implemented method 500 of directing a service provider to a user, according to yet another embodiment of the present invention. The method 500 is implemented in a computer system comprising a memory unit and a processor. The memory unit stores a database comprising one or more records associated with a plurality of service providers. The records comprise at least one of names, locations of a plurality of service providers as well as a first list of services offered by the plurality of service providers. The first list of services provided comprise at least one of a hunting expedition service, an art museum tour service, a city tour service, a cultural tour service, a culinary tour service, and a historical tour service. Further, the records comprise age of the plurality of service providers, sex of a plurality of service providers, and a list of languages spoken by the plurality of service providers. The plurality of service providers are connected to a plurality of electronic devices. The plurality of electronic devices comprise laptops, personal computers, smart phones, smart televisions, and tablet computers. The plurality of electronic devices comprise Global Positioning System (GPS) modules. Further, the memory unit stores a set of program modules. Moreover, the computer system comprises a processor. The method 500 commences at step 505.

At step 510, information about the user is received at an input module executed by the processor. In one embodiment of the present invention, information about the user pertains to at least one of name of the user, and a second list of services required by the user. At least one service request comprises information regarding a service requested by the user, an age preferred by the user and a language spoken by the user. An example of the service required by the user includes, but is not limited to a request for a hunting expedition service, an art museum tour service, a city tour service, a cultural tour service, a culinary tour service, and a historical tour service. In one example, the user enters logs in to the computer system via the input module. The input module receives profile information about the user. The profile information comprises age, sex, and credit card number of the user. The input module transmits the profile information to an administration unit and is stored in a database. Further, the user inputs a list of services required by the user. Further, the user transmits location of the user to the administrative unit. The administrative unit identifies the user from a description Module. Further, the administrative unit identifies at least one service provider from the description module, retrieves information from a mapping module, performs business logic to match user with the at least one service providers.

At step 515, a location of the user is determined at a location detection module executed by the processor. In one embodiment of the present invention, the location detection module is implemented in Application Specific Integrated Circuit Chip. The location detection module communicates with a GPS module of a user terminal of the user. Further, the location detection module receives one or more data items from the GPS module and determines the location of the user based upon the one or more data items. The one or more data items comprise information regarding coordinates of the user in accordance with one of a radial, linear and cartographical system.

At step 520, availability of the service provider is determined by a service provider availability module executed by the processor. Further, compatibility of the first list of services with the second list of services is calculated via a compatibility module. Further, the compatibility module calculates compatibility of the personal details of the service provider with the user preferences. Further, a service provider selection module assigns the at least service provider to the user, based on the list of services required by the user being compatible with the list of services offered by the at least one service provider and the personal details of the service provider being compatible with the user preferences. Furthermore, a security key generator module generates a security key.

The service provider availability module analyses the records associated with the plurality of service providers. It is noted that the records comprises locations of the plurality of service providers. Further, the service provider availability module selects at least one service provider from the plurality of service providers based upon the service provider being in vicinity of the location of the user. Moreover, the service provider availability module analyses one or more records associated with the service provider. If the service requested by the user is among the list of services offered by the service provider, then the service provider availability module determines the service provider to be available. In another embodiment, the service provider availability module determines the service provider to be available, if the service provider has the age preferred by the user. In yet another embodiment, the service provider availability module determines the service provider to be available, if the language spoken by the user is among the list of languages spoken by the service provider.

At step 525, the service provider is assigned to the user by a service provider selection module. In one example, the service provider selection module uses a communication module within the administrative unit to send a list of the service providers within in vicinity to the administrative unit. The input module receives an input from the user and selects at least one service provider based on the input. In one example, the input is a mouse click. The administrative unit initiates a billing Module to calculate a bill. The administrative unit further initiates a request to a security key generating module. The security key generating module generates a security key. The administrative unit transmits the security key to the user. The service provider arrives at the location of the user and the user relays the security key verbally to the service provider. The service provider enters the security key into a security module. The security key is transmitted to the administrative unit and a check is done to confirm a match. If there is a match, the service provider provides a service to the user. The administrative unit initiates a clock countdown based on a designated activity time segment. The administrative unit counts down until 10 minutes before end of designated activity in the service providers profile and a message is sent to user to ask if the user agrees to extend the service. If the user agrees, a new designated extension time is assigned. The administrative unit stores service provider profile information that has been previously entered into the administration unit by the service provider via at least one of a web page and an application window. Profile information includes but is not limited to name, address, phone number and profile characteristics comprising age, sex, services provided. This service provider database is queried by the user app requests.

At step 530, the service provider is paired to the user. The communication module transmits the location of the user to at least one service provider. The communication module transmits the security key to the user. When the service provider arrives to provide the service requested by the user, the user verbally relays the security code to the service provider. The service provider enters the security code. The communication module transmits the security key to the administration module. The processor assigns at least one service provider to provide the first list of services, to the user, thereby pairing the at least one service provider with the user.

To direct the service provider to the user, the communication module transmits the location of the user to at least one electronic device among the plurality of electronic devices. The electronic device is associated with the service provider. Further, the communication module transmits at least one service request to the electronic device. Further, the communication module requests the service provider to perform the service as described by at least one service request, thereby directing the service provider to the user.

The method 500 ends at step 535.

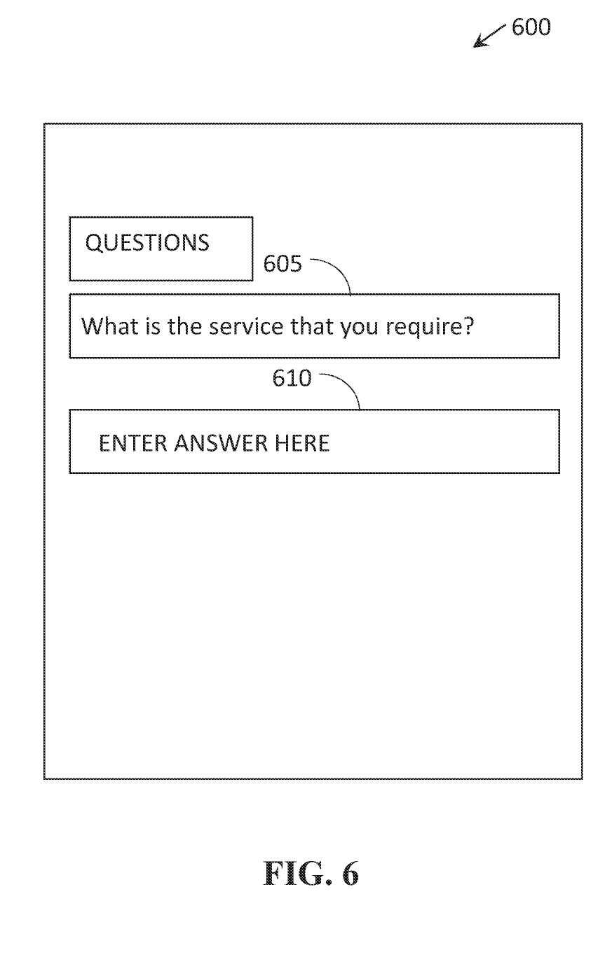

FIG. 6 is a screenshot view of a service request screen 600 according to yet another embodiment of the present invention. The service request screen 600 comprises a question box 605 and an answer box 610. The question box 605 displays a question directed towards at least one user. In one example, the question is “What service do you require?” The service request screen 600 invites at least one user to input a service required by the user in the answer text box 610.

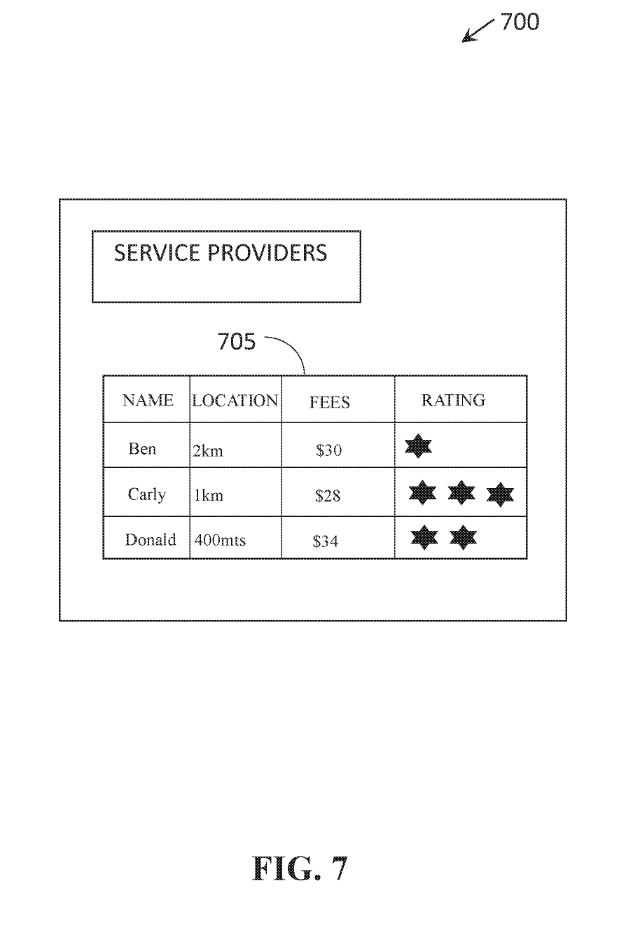

FIG. 7 is a screenshot view of a user screen 700 according to yet another embodiment of the present invention. The user screen 700 comprises a table 705 as displayed to a user. In one example, the user screen 700 displays a set of icons overlaid on a map screen instead of the table 705. Each icon represents a service provider. The user is enabled to view the set of icons, click on the icon and get information about each provider. The table 705 comprises information about a plurality of service providers assigned by a service provider selection module. The information comprises location of the plurality of service provider, fees charged by the plurality of service providers, and rating of the plurality of service providers. In one example, the user is enabled to select at least one service provider from the table 705. A communication module executed by the processor directs at least one service provider to the user.

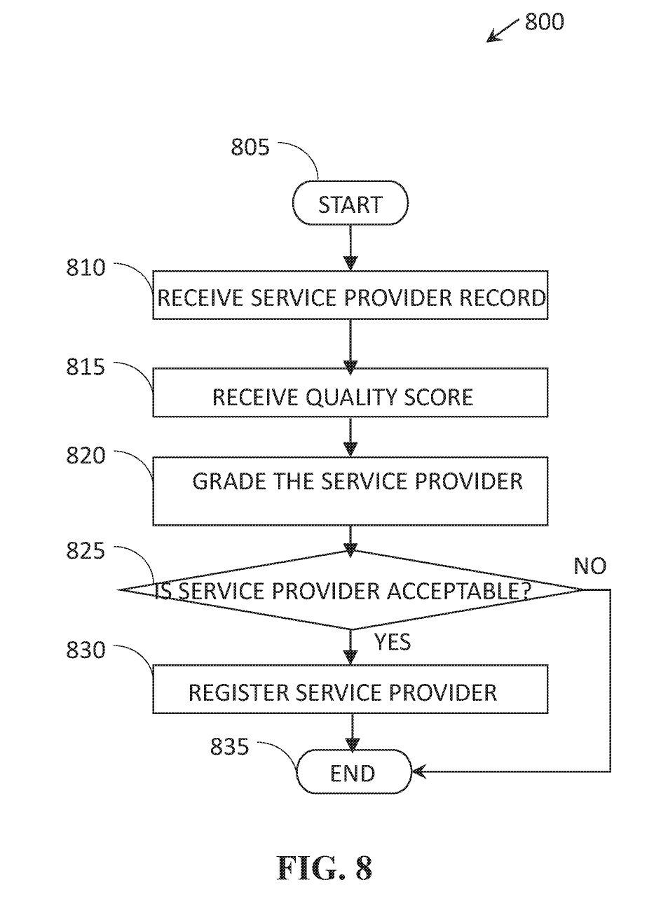

FIG. 8 is a flow chart illustrating a computer-implemented method 600 of registering a service provider in a system, according to yet another embodiment of the present invention. The method 800 is implemented in a computer system comprising a memory unit and a processor. The memory unit stores a database comprising one or more records associated with a plurality of service providers. Further, the memory unit stores a set of program modules. Moreover, the computer system comprises a processor. The method 800 commences at step 805.

At step 810, a record of the service provider is received at an input module executed by the processor. The record comprises at least one of a name, a location of the service provider as well as a list of services offered by the service provider. The service provider is connected to an electronic device. Examples of the electronic device comprise laptops, personal computers, smart phones, smart televisions, and tablet computers. The list of services provided comprise at least one of a hunting expedition service, an art museum tour service, a city tour service, a cultural tour service, a culinary tour service, and a historical tour service.

At step 815, a quality score for the service provider is received at the input module. In one example, the quality score is a numerical representation of quality of the service provider. In one embodiment of the present invention, the quality score is received from a plurality of users registered with the system. The plurality of users assign the quality score based upon the service provider having a set of user-specified qualities. In one example, the set of user-specified qualities comprises apparent honesty, apparent loyalty, apparent punctuality, apparent passion, and apparent compassion. In another embodiment, the quality score is received from the processor. The processor assigns the quality score based on information in the record associated with the service provider. In an exemplary illustration of the working of the present invention, the service provider is assigned a quality score of 7.

At step 820, the service provider is graded into one of acceptable and unacceptable, by the processor, based upon the quality score. If the quality score is above a threshold quality score, then the service provider is graded as acceptable. Otherwise, the service provider is graded as unacceptable.

At step 825, if the service provider is acceptable, then the method 800 proceeds to step 830. Otherwise, the method 800 proceeds to step 835.

At step 830 the service provider is registered in the system. To register the service provider, the record associated with the service provider is added to the database with the one or more records in the memory unit. The quality score is a cumulative average. The record of the quality score of a service provider is updated each time a grade is received from a user and the processor calculates an average score which the processor then grades as acceptable or not acceptable.

The method 800 ends at step 835.

Advantageously, the present invention enables users having a wide range of experience and expertise to earn money. Further, the present invention enables users to share experience and expertise based on real time requests by other people. Furthermore, the present invention enables the users to access on-demand, instant booking and access to a wide variety of activities. The users are enabled to choose go for a plurality of activities without pre-booking. Matching of system users with guides based on profile characteristics and ranking best fit guides based on distance and time from requester (location and estimated ETA until tour start), age range, and language requested. The system has logic and rules for service provider matching and user matching.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for pairing a service provider with a user, the system comprising:
a memory unit to store:
a database comprising one or more records associated with at least one service provider, and
a set of program modules,
wherein the one or more records comprise information regarding location of at least one service provider and personal details of the at least one service provider, the personal details comprising a first list of services offered by the service provider, age of the service provider, and languages known to the service provider;
a processor to execute the set of program modules, wherein the set of program modules comprise:
an input module, executed by the processor, configured to receive information about the user, wherein information about the user comprises name and user preferences of the user, the user preferences comprising age of the service provider as preferred by the user, location of the service provider as preferred by the user, a second list of services required by the user, and languages spoken by the service provider as preferred by the user;
a location detection module, executed by the processor, configured to determine a location of the user;
a service provider availability module, executed by the processor, configured to determine availability of at least one service provider in a vicinity of the location;
a compatibility module, executed by the processor, configured to:
calculate compatibility of the first list of services with the second list of services, and
calculate compatibility of the personal details of the service provider with the user preferences;
a service provider selection module, executed by the processor, configured to select and assign the at least service provider to the user, based upon the first list of services being compatible with the second list of services and the personal details of the service provider being compatible with the user preferences;
a security key generator module, executed by the processor, configured to generate a security key; and
a communication module, executed by the processor, configured to:
transmit the location of the user to at least one service provider,
transmit the security key to the user, and
request at least one service provider to provide the first list of services offered by the at least one service provider, to the user, thereby pairing the at least one service provider with the user.

2. The system of claim 1, wherein the first list of services comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service.

3. The system of claim 1, wherein the second list of services comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service.

4. The system of claim 1, wherein the location detection module determines the location of the user with a Global Positioning System (GPS).

5. The system of claim 1, wherein the security key enables the user to authenticate the at least one service provider.

6. The system of claim 1, wherein the service provider is at least one of a professional service provider and an amateur service provider.

7. The system of claim 1, wherein the personal details of the service provider are compatible with the user preferences based on the personal details being identical to the user preferences.

8. A computer implemented method of pairing a service provider with a user, comprising:
storing one or more records associated with at least one service provider in a computer system, wherein the one or more records comprise information regarding location of at least one service provider and personal details of the at least one service provider, the personal details comprising a first list of services offered by the service provider, age of the service provider, and languages known to the service provider;
receiving, at a processor, via an input module, information about the user, wherein information about the user comprises name and user preferences of the user, the user preferences comprising age of the service provider as preferred by the user, location of the service provider as preferred by the user, a second list of services required by the user, and languages spoken by the service provider as preferred by the user;
determining, at the processor, via a location detection module, a location of the user, with a location detector module;
determining, at the processor via a service provider availability module, availability of the at least one service provider in a vicinity of the location of the user;
calculating, at the processor, via a compatibility module, compatibility of the first list of services and the second list of services;
calculating, at the processor, via a compatibility module, compatibility of the personal details of the service provider with the user preferences;
assigning, at the processor, via a service provider selection module the at least service provider to the user, based upon the first list of services being compatible with the second list of services and personal details of the service provider being compatible with the user preferences;
generating, at the processor, via a security key generator module, a security key;
transmitting, at the processor, via a communication module, the location of the user to at least one service provider;
transmitting, at the processor, via the communication module, the security key to the user;
transmitting, at the processor, via the communication module, the security key to the service provider; and
requesting, at the processor, via the communication module, the at least one service provider to provide, the first list of services to the user.

9. The method of claim 8, wherein the list of services offered by the at least one service provider comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service.

10. The method of claim 8, wherein the list of services required by the user comprises at least one of a hunting expedition service, an art museum tour service, a city tour service, a cultural tour service, a culinary tour service, and a historical tour service, a beer brewing service, a fish delivering service, an equipment repair service, a web designing service, a real estate brokerage service, a medical service, a sanitation service, a construction service, and an event management service.

11. The method of claim 8, wherein the location detection module determines the location of the user with a Global Positioning System (GPS).

12. The method of claim 8, wherein the security key enables the user to authenticate the at least one service provider.

13. The method of claim 8, wherein the service provider is at least one of a professional service provider and an amateur service provider.

14. The method of claim 8, wherein the service provider is registered with the database.

15. A non-transitory program storage device readable by computer, and comprising a program of instructions executable by a processor to perform a computer implemented method of pairing a service provider to a user, comprising:
storing one or more records associated with at least one service provider in a computer system, wherein the one or more records comprise information regarding location of at least one service provider and personal details of the at least one service provider, the personal details comprising a first list of services offered by the service provider, age of the service provider, and languages known to the service provider;
receiving, at a processor, via an input module, information about the user, wherein information about the user comprises name and user preferences of the user, the user preferences comprising age of the service provider as preferred by the user, location of the service provider as preferred by the user, a second list of services required by the user, and languages spoken by the service provider as preferred by the user determining, at the processor, via a location detection module, a location of the user, with a location detector module;
determining, at the processor via a service provider availability module, availability of the at least one service provider in a vicinity of the location of the user;
calculating, at the processor, via a compatibility module, compatibility of the first list of services with the second list of services;
calculating at the processor, via the compatibility module, compatibility of the personal details of the service provider with the user preferences;
assigning, at the processor, via a service provider selection module the at least service provider to the user, based upon the list of services required by the user being compatible with the list of services offered by the at least one service provider and the personal details of the service provider being compatible with the user preferences;
generating, at the processor, via a security key generator module, a security key;
transmitting, at the processor, via a communication module, the location of the user to at least one service provider;
transmitting, at the processor, via the communication module, the security key to the user; and
requesting, at the processor, via the communication module, at least one service provider to provide the first list of services to the user, thereby pairing the at least one service provider with the user.
